(19) United States
(12) Patent Application Publication
(10) Pub. No.: US 2008/0195601 A1
(43) Pub. Date: Aug. 14, 2008

(54) Method For Information Retrieval

(75) Inventors: Alexandros Ntoulas, Los Angeles, CA (US); Gerald C. Chao, Los Angeles, CA (US)

Correspondence Address: Vista IP Law Group LLP, 2040 MAIN STREET, 9TH FLOOR, IRVINE, CA, 92614, US

(73) Assignee: THE REGENTS OF THE UNIVERSITY OF CALIFORNIA, Oakland, CA (US)

(21) Appl. No.: 11/911,191

(22) PCT Filed: Apr. 13, 2006
(86) PCT No.: PCT/US2006/014358

§ 371 Date: Oct. 10, 2007

Related U.S. Application Data
(60) Provisional application No. 60/671,396, filed on Apr. 14, 2005.

(51) Int. Cl. G06F 17/30

(52) U.S. Cl. 707/5; 707/102; 707/E17.017

(57) ABSTRACT

A method of retrieving documents using a search engine includes providing a reverse index including one or more keywords and a list of documents containing the one or more keywords, the reverse index further including a measure of confidence (MOC) value associated with the one or more keywords. One or more query terms are input into the search engine. The query terms are disambiguated and a MOC value is associated with each meaning of the disambiguated query term. A list of documents is retrieved containing the query terms wherein the documents are initially ranked based at least in part on the MOC values of the keywords and query terms. The list of documents may be re-ranked based at least in part on the semantic similarity of each document to the disambiguated query terms.

### REFERENCE TO RELATED APPLICATIONS

This Application claims priority to U.S. Provisional Patent Application No. 60/671,396 filed on Apr. 14, 2005. U.S. Provisional Patent Application No. 60/671,396 is incorporated by reference as if set forth fully herein.

### FIELD OF THE INVENTION

The field of the invention generally relates to information retrieval methods, and more particularly, to a method and system for information retrieval that improves the relevance of search results obtained using a search engine. In one aspect of the invention, a method and system for retrieving documents or web pages uses a search engine to provide relevant information to the user. Information retrieval is based, at least in part, on the use of adaptive language processing methods to resolve ambiguities inherent in human language.

### BACKGROUND OF THE INVENTION

Current search engines rank search results based on many assumptions that must be predetermined in advance. These assumptions can be, for example, the users' desired information or goal, whether they are looking for specific content they have seen before, researching a novel topic, or locating some resource. Many times, the search engine must assume the meanings of ambiguous queries submitted by the requester. Such ambiguous queries are common due to the nature of short queries input to the search engine. Moreover, in many languages, particularly the English language, words have multiple meanings. Finally, ambiguities will often arise due to poorly formed queries. In these situations current search engines make broad assumptions, implementing so-called “majority rules.” For example, a search engine might assume that an user issuing the query of “jaguar” is looking for the JAGUAR automobile because that is what 80% of the users were looking for previously. These assumptions, however, often turn out to be incorrect.

Consequently, it becomes increasingly difficult for search engines to look for the non-majority usages of terms. Conventional search engines thus have difficulty “searching beyond the norm.” For example, if a user is looking for the Jaguars football team or the JAGUAR operating system produced by APPLE COMPUTER, the requester would have to add additional query words to their searches. Alternatively, the requester would have to attempt using complex “advanced search” features. Either method, however, does not necessarily guarantee better results. As a result, requesters are often left to wade through pages and pages of irrelevant documents. This problem is only exacerbated by the ever increasing volume of content that is being created and archived.

Most current search engines locate pages or documents based on one or more “keywords,” which are usually defined by words separated by spaces and/or punctuation marks. Search engines usually first pre-process a collection of documents to generate reverse indexes. An entry in a reverse index contains a keyword, such as “watch” or “check,” and a list of documents within the collection that contain the keyword of interest. When a user issues a query such as “watch check babysitter” to the search engine, the search engine can quickly retrieve the list of documents containing these three keywords by looking up the reverse indexes. This avoids the need to search the entire collection of documents for each query, which of course, is a time consuming process. Recently, more sophisticated search engines, such GOOGLE and TEOMA, improve keyword searching by prioritizing the search results via measures of relevancy based on how the stored documents reference each other via hypertext links. For example, a higher degree of linking may be used as a proxy for relevancy.

Unfortunately, keyword-based search engines fail to account for the many ambiguities present in all natural (e.g., human) languages. For example, the word “driver” has multiple meanings. For example, “driver” may refer to an operator of a vehicle, a piece of computer software, a type of tool, a golf club, and the like. When a user is seeking documents containing a particular type of driver, he or she can either: (1) sort through the results manually to eliminate documents using a different meaning of “driver,” or (2) compose complex queries to make the request less ambiguous, such as “(golf (driver or club)) and not (golf cart driver),” or (3) wade through the “advanced search” interface(s) in order to reduce the irrelevant documents returned by the search engines. These options are, however, time consuming, tedious, and require users to impart additional efforts in understanding, or worse, adapting to their own search to a search engines particular to improve their search results.

A better model is for the search engine to comprehend or “understand” the documents as humans reading them would. As such, the search engine would extract the meanings commonly understood to those reading the document or web page. In doing so documents or web pages are organized based on the meanings of the words and not the words themselves. In this scenario the number of irrelevant documents can be greatly reduced, thereby improving the user's experience and the search engine's effectiveness in retrieving relevant documents. Unfortunately, understanding natural language texts requires resolving ambiguities inherent in all natural languages, a task that can be difficult even for humans. Similarly, computer programs written to analyze words contained in documents are also unable to resolve these ambiguities reliably.

Current search engines suffer from the limitation in that they leave these linguistic ambiguities unresolved. Attempts have been made, however, to develop models aimed to mitigate this problem. Generally, the most common approaches can be divided into two major groups: (1) feature-based models and (2) language-based models. Feature-based models extract features from documents and convert them into predefined representations, such as feature vectors, categories, clusters, and statistical distributions. These transformations enable the approximation of the closeness in meaning between documents and the requesters' queries by calculations done using these representations. Unfortunately, these representations need to be stored in addition to the index, thereby greatly increasing the storage requirements of the search engine utilizing such a system. This option is less desirable for most large-scale search engines capable of handling the number of documents and web pages contained on a network such as, for instance, the Internet. One can reduce the size of these representations to save space, but this also decreases their effectiveness and, thus, their utility.

Furthermore, these approaches still rely on “shallow” features, i.e., the words themselves, to approximate the underlying semantics. That is, current models treat the documents as “bag of words,” where each word is represented by its presence and neighboring words. Therefore, these approaches ignore the well-formed structures of natural language, a simplification with several problems. The following four sentence fragments illustrate the problem with these models:
(1) “painting on the wall”
(2) “on painting the wall”
(3) “on the wall painting”
(4) “the wall on painting”

Because these four fragments contain the same four words, a “bag of words” model will treat them all as semantically equivalent, i.e., having the same meaning. A human reader, however, would easily see that this is not the case. One improvement is to retain ordering and proximity information of these keywords, but the true semantic meaning remains inaccessible. For example, assume a user queries a search engine with “Apple” and “fell.” A search engine based on the so-called shallow features will find the following three sentences equally relevant because “Apple” and “fell” appear next to each other:
(1) “Apple fell”
(2) “Shares of Apple fell”
(3) “The man who bought shares of Apple fell”

A human reader would understand that it is “shares” and “the man” that fell in the second and third sentence, respectively. It is all too common for a user to read a document returned by a search engine to find its irrelevance because of the engine's ignorance of such linguistic ambiguities.

A different approach is for a search engine to analyze the documents to extract their meaning—an area of research called natural language processing (NLP). This field studies various approaches that can best resolve language ambiguities, including linguistics based, data-driven, and semantics based techniques. The goal is to recover the semantics intended by the author. For example, the model may identify the computer software meaning of “driver” in the following sentence:

“The driver needed by the Golf computer game can be found here.”

A search engine can then create indices based on the meaning instead of the keywords, i.e., a semantic index or conceptual index. A user looking for a software driver using such a search engine would not be inundated with documents regarding golf clubs or vehicle operators, for example. Moreover, structural ambiguities such as the “Apple fell” example discussed above are also resolved to properly identify the long-distance dependences between words.

There are two major obstacles preventing a search engine from realizing these benefits of NLP techniques. These include accuracy and efficiency. Although NLP's accuracy has been steadily improving, it has not improved the accuracy of information retrieved on a large scale. This is because the accuracy level of resolving linguistic ambiguity (i.e., disambiguation) is still lacking, and thus the errors made cancel the benefits NLP provides. One reason for this canceling effect is that the information retrieval (IR) models usually accept only one interpretation from the NLP systems. In doing so, however, disambiguation errors are treated as correct by the IR systems, thus producing the nullifying effect.

The second challenge is efficiency. Because of the voluminous nature of the number of documents linked to the Internet, processing large amounts of text can be too time consuming to be practical. For example, full analyses of sentential structures, i.e., parsing, requires a significant amount of time (e.g., at least polynomial time). Resolving references made with articles and pronouns can involve complex aligning procedures. Reconstructing the structure of a discourse requires complex record-keeping and sophisticated algorithms. Therefore, applications of these more “in-depth” NLP techniques are hampered by the amount of computational resources needed, especially dealing with the enormity and fast-growing collection on the Internet.

Related to the efficiency issue is accuracy. While algorithms that avoid in-depth analysis exist and thus reduce the amount of computation resources needed, they come at a price of lowered accuracy. That is, the improved efficiency is made possible by ignoring, for example, long-distance dependencies and complex relations within texts. The challenge is in striking a delicate balance between accuracy, efficiency, and practicality. Thus, the goal is to provide an information retrieval system and method that can accurately resolve natural language ambiguities to improve the system's search quality, while at the same time is efficient such that it can be used to index large collections such as the Internet and keep pace with its phenomenal growth.

There thus is a need for a system and method that efficiently searches and identifies relevant information for a requestor. The system and method would advantageously account for lexical ambiguities. Moreover, in certain embodiments, the method would provide the user with a simple way to eliminate results that are unwanted. The system and method also would present the most relevant information to the requester in a manner that mitigates or eliminates entirely the process of wading through lists of unrelated or irrelevant documents.

### SUMMARY OF THE INVENTION

In one aspect of the invention, an improved system and method for information retrieval is provided that improves the resolution of ambiguities prevalent in human languages. This system and method includes four main components including: (1) an adaptive method for natural language processing, (2) an improved method for incorporating language ambiguities into indexes, (3) an improved method for disambiguating requesters' queries, and (4) an improved method for generating user feedback based on the disambiguated queries.

In one aspect of the invention, the language processing used in the present invention is an adaptive and integrative approach to resolve ambiguities, referred to as Adaptive Language Processing (ALP) module. The ALP module is adaptive in the sense that it balances the need for accuracy and efficiency. The process begins with resolving part-of-speech and word sense ambiguities based on local information, making it more efficient. However, if additional analysis is performed, such as chunking, full parsing, anaphora resolution, etc., the NLP model leverages this additional information to improve the method's accuracy. Consequently, the method balances efficiency with accuracy, in that ambiguities are quickly resolved in a first pass, and if more accuracy is needed, more computation can be allocated.

An important aspect of ALP's output, which is also maintained throughout the IR model, is a measure of confidence (MOC) parameter or value. This MOC value represents the amount of confidence, or conversely, the amount of ambiguity, the model associates with each ambiguous decision. Because current NLP models are not 100% accurate, and because some ambiguities can sometimes be intentional, the present invention entertains multiple interpretations as well as their associated confidence measures. The MOC value allows the model to better integrate multiple sources of ambiguities into interpretations that are more semantically coherent. The result is reduced retrieval errors, an improved user experience, as well as improved reliability as NLP technology improves.

For example, using the earlier “driver” query, the ALP module is not forced to make only a single decision for “driver,” a difficult task because of the limited context. Instead, the ALP module produces a MOC value for each possible meaning, such as 50% confident for the “software driver” meaning, 35% confident for the “golf club” meaning, etc. This measure is then maintained and utilized throughout the IR model to improve search quality. The MOC value may also be retained to provide user assistance.

In one aspect of the invention, a user's query is processed by the following steps. First, a list of documents or web pages and associated MOC values are retrieved from the reverse indexes. These MOC values are then used to disambiguate the user's query via a “confidence intersection” formed by a matrix of the various ambiguous meanings attributable to a particular query vis-à-vis the number of documents containing the queried term(s). The documents or web pages are then sorted based on the disambiguated query, presenting more semantically relevant results higher on the list. Optionally, a list of alternative interpretations of the query is provided for the user. If the wrong interpretation is chosen initially, users can readily choose the correct one and quickly eliminate irrelevant results.

An additional benefit of the semantic-based IR model enabled by NLP is its ability to suggest additional search terms based on conceptual similarity. The uniqueness of this approach is that the suggestions are more relevant since they are based on the disambiguated queries. Furthermore, the suggestions are compiled automatically during the language analysis step done by the ALP module. These suggestions are linguistically correct and semantically disambiguated. Moreover, the suggestions reflect and adapt to the ever-changing body of documents searched by the search engine. Consequently, these suggestions provide to the users instant access to relevant documents that are semantically similar to their current query.

In one aspect of the invention, a method of indexing documents for use with a search engine includes the steps of identifying the words contained in a document. The words are processed in an adaptive language processing module so as to associate each word with a measure of confidence (MOC) value, the MOC value being associated with a particular meaning of the word. Each word and its MOC value is stored in a reverse index along with location information for the document. The documents may be indexed using, for example, a crawler and an indexer.

In the method described above, each word within a document may also be associated with a part-of-speech tag identifying the grammatical usage of the word within the document. The part-of-speech tag may be associated with a MOC value. In addition, in the method described above, each word within a document may also be associated with a word sense value identifying a particular meaning of the word. The word sense value may be associated with a MOC value.

In still another embodiment of the invention, a method of retrieving documents using a search engine includes providing a reverse index including one or more keywords and a list of documents containing the one or more keywords, the reverse index further including a MOC value associated with the one or more keywords. One or more query terms are input to the search engine. Based on the input query terms, one or more meanings of the query terms are identified and each meaning is associated with a MOC value. A list of documents is then retrieved containing the one or more query terms, wherein the documents are ranked at least in part on the MOC value associated with the one or more keywords contained in the document and the MOC value associated with each query term meaning.

In one preferred aspect of the invention, the documents having a keyword meaning most similar to the query term with the highest MOC value are ranked higher. This ranked list may be presented to the user on his or her computer (or other device) to provide a list of documents that are more relevant than lists returned by conventional search engines.

In one aspect of the invention, the user may be presented with one or more alternative queries. The one or more alternative queries may comprise known phrases formed by consecutive query terms. The alternative queries may be ranked according to their respective usage frequencies. Alternatively, the one or more alternative queries may be based at least in part on speech pairings of multiple keywords contained within the documents. In yet another embodiment, the alternative queries may be based in part on synonym(s) of one more query terms. Alternatively, the one or more queries may be based in part on definition(s) of the input query terms. In still another aspect, the alternative queries may be based at least in part on the disambiguated query. The alternative queries may also be presented to the user in a ranked order. For example, alternative queries may be ranked based on usage frequency or on semantic similarity to the input query.

In another embodiment of the invention, a method of retrieving documents using a search engine includes providing a reverse index including one or more keywords and a list of documents containing the one or more keywords, the reverse index further including a MOC value associated with the one or more keywords. One or more query terms are input into to the search engine. The query terms are disambiguated by obtaining a MOC value for each query term based at least in part on the meaning of each query term. A list of documents is retrieved containing the one or more query terms, wherein the retrieved documents are initially ranked based at least in part on the MOC value associated with the keyword contained in document and the measure of confidence value associated with each query term meaning. The list of documents is then re-ranked at least in part based the semantic similarity of each document to the disambiguated query. The semantic similarity of a document to the disambiguated query may be determined by looking up pre-computed distanced between every two concepts within an ontology.

In another embodiment of the invention, a method of retrieving documents using a search engine includes submitting a query to a search engine and presenting a user with a list of documents, the list including an exclusion tag associated with each document in the list. One or more exclusion tags in the list are selected to exclude one or more documents. Next, a similarity measure is determined for each document in the list based at least in part on the similarity of the document to those documents associated with a selected exclusion tag. The list is then re-ranked based on the determined similarity measure, wherein those documents most similar to the excluded documents are demoted or removed from the re-ranked list.

The user may also be presented with a list of a list of categories, wherein each category includes an exclusion tag associated therewith, wherein selection of the exclusion tag associated with a particular category excludes documents from the re-ranked list that fall within the particular category.

In another aspect of the invention, an improved method for ranking the relevance of search results is provided. This method includes three general steps including: (1) providing a user-interface component that is easy for requesters to specify the results they do not want (the documents to eliminate), (2) computing a similarity measure of all the results to those eliminated, and (3) based on the similarities, re-ranking the results list so those with similar content to the eliminated documents are ranked lower or removed entirely.

According to still another embodiment of the invention, a method of retrieving documents using a search engine includes establishing a user preference for a plurality of categories of documents, submitting a query to a search engine, determining a similarity measure between the documents based at least in part on the similarity of the documents to the established category preferences, and presenting the user with a list of documents, wherein the documents are ranked based on the determined similarity measure.

It is thus an object of the invention to provide a method and system for retrieving information using a search engine. The method and system provides more relevant documents to a user by efficiently and accurately resolving linguistic ambiguities contained in both documents and submitted queries. A method is also provided that permits the display or presentation of the most relevant documents to a user. Irrelevant or un-wanted documents can easily be removed from returned query lists to limit or eliminate the need to sift through pages of returned documents. Further features and advantages will become apparent upon review of the following drawings and description of the preferred embodiments.

### BRIEF DESCRIPTION OF THE DRAWINGS

FIG. 1 schematically illustrates one embodiment of an information retrieval system and method according to one embodiment of the invention.

FIG. 2 schematically illustrates one embodiment of a system and method for processing a query to retrieve relevant documents.

FIG. 3 schematically illustrates one embodiment of a system and method for a results processor that integrates the outputs of several other modules of the information retrieval system to formulate, among other things, a list of relevant documents.

FIG. 4A illustrates a document (document #72) being processed by an adaptive language processing (ALP) according to one aspect of the invention.

FIG. 4B illustrates a second document (document #118) being processed by an adaptive language processing (ALP) according to one aspect of the invention.

FIG. 4C illustrates a third document (document #300) being processed by an adaptive language processing (ALP) according to one aspect of the invention.

FIG. 4D illustrates a method for processing a query input by a user according to one embodiment of the invention.

FIG. 4E illustrates a process for forming a confidence matrix based on the disambiguated query and reverse index entry for the keyword “stall.”

FIG. 4F illustrates a process for resolving query ambiguity using multiple keywords of a query search (in this case “stall” and “engine”).

FIG. 4G illustrates a process wherein alternative queries are suggested to the user based on the disambiguated query terms.

FIG. 5 illustrates a results display according to one embodiment of the invention, as seen, for example, on a user's computer via a browser or the like. The displayed results illustrate a ranked list of relevant documents as well a brief document summary, a list of alternative interpretations for the input query as well as a suggested list of conceptually related query terms.

FIG. 6 illustrates a user interface for presenting results to a user according to another embodiment of the invention.

FIG. 7 illustrates a re-ranked list of documents presented to a user. The re-ranked list excludes those documents checked or otherwise tagged by the user to exclude. The excluded document(s) is replaced with other documents that are similar to those that were not removed or excluded.

FIG. 8 illustrates a re-ranked list of documents presented to a user. The re-ranked list shows the results after the user removed an entire category of documents (in this case Motorsports/Auto Racing). All documents within this category as well as other semantically-related documents are removed and replaced with more relevant documents.

FIG. 9 illustrates a user preference screen where a user selects his or her level of interest in a plurality of categories. The interest level of each category may be selected by the user.

### DETAILED DESCRIPTION OF THE PREFERRED EMBODIMENTS

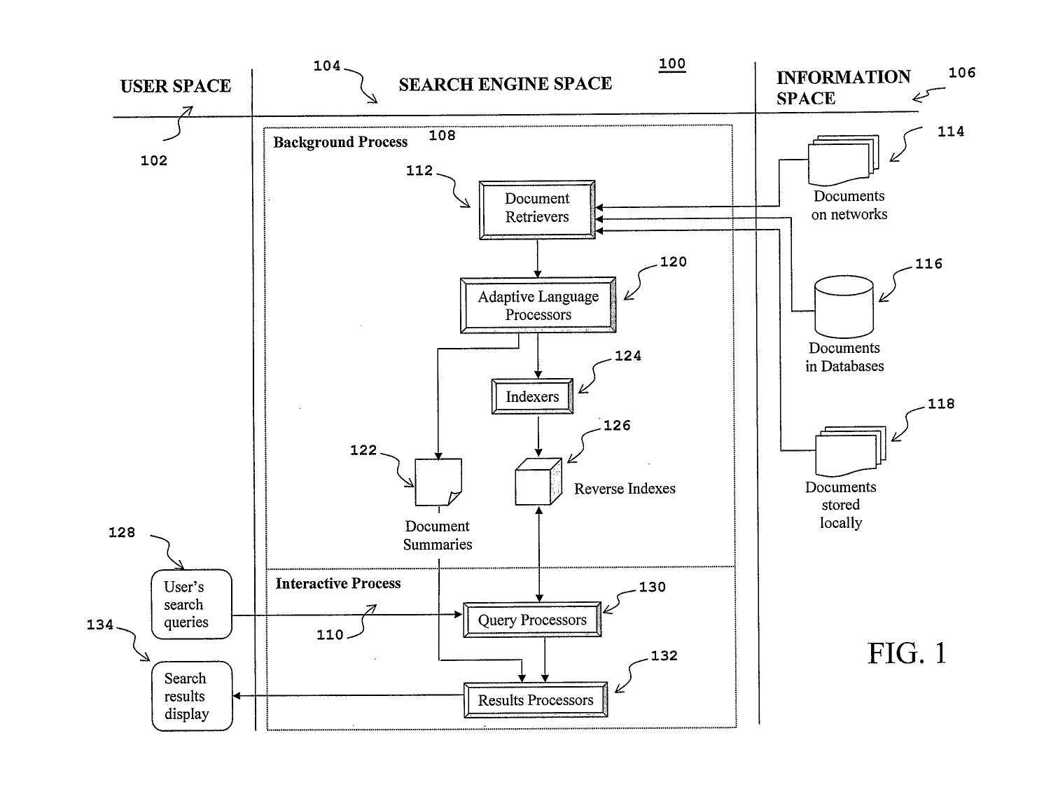

FIG. 1 schematically illustrates a system and method for information retrieval 100. The system and method 100 is generally divided into three spaces including a user space 102, a search engine space 104, and an information space 106. The search engine space 104 is divided into a background process 108 and an interactive process 110. Indexing of documents occurs in the background process 108 while user queries and their associated results are part of the interactive process 110. Referring to FIG. 1, a document retriever 112 is given access to the information space 106 such that documents are transferred or otherwise communicated to the search engine space 104. In the context of the present invention, the term document refers to actual documents or web page(s) or the like that are searchable using a search engine. Documents may be located on networks 114 (e.g., the Internet), within one or more databases 116, or stored locally 118 on a computer (e.g., on a local drive or other storage media). In search engine parlance, this document retriever 112 module or component is often called a crawler or bot. For efficiency reasons, multiple crawlers are used in parallel to download documents from web sites on the Internet.

Still referring to FIG. 1, the documents obtained using the document retriever are then processed by the Adaptive Language Processing (ALP) module 120. The ALP module 120 resolves language ambiguities and associates a measure of confidence (MOC) for the words contained within the retrieved documents. The importance of the MOC measure will be discussed in more detail below. The ALP module 120 can resolve a plurality of language ambiguities. As one illustrative example, the ALP module 120 uses word senses to resolve ambiguities. For example, the ALP module 120 will produce a MOC output value that it is 0.6 confident that the word “driver” has the “golf club” meaning, versus 0.2 confident for the “software” meaning, 0.05 confident for the “tool” meaning, etc. Additionally, the ALP module 120 may contain part-of-speech (POS) tags generated by the ALP module 120 for each word. For instance, with respect to the word “live,” a speech tag indicates whether it is being used as a verb or an adjective.

Thus a sample output from the ALP module 120 for the sentence “He found a driver” would be the following:

He PRP(1.0)[#1(1.0)]

found VBD(0.8)[#1(0.4)/#2(0.5)/#3(0.1)] ADJ(0.1)[#1(1.0)] NN(0.1)[#1(1.0)]

a DT(1.0)[#1(1.0)]

driver NN(1.0)[#1(0.4)/#2(0.3)/#3(0.3)]

The symbol following the word is the part-of-speech tag (PRP for pronouns, VBD for past tense verbs, DT for determiners, and NN for nouns). The number appearing after the POS tag is the MOC value generated by the ALP module 120, such as 0.8 for “found” being a verb and 0.1 for being an adjective. Following the POS tags are the word sense numbers and their respective MOC values. In this example, “driver” has three noun senses, and due to the ambiguous context, all three senses are almost equally likely.

Additionally, the ALP module 120 generates optional document summaries 122, which are used when search results are returned to the users. The document summaries 122 can be simply the textual portions of the original documents, or condensed versions of the documents like an abstract or synopsis. The document summaries 122 may be presented to the user adjacent to each document identified in a search result list.

The ALP module 120 outputs, along with the associated MOC values, are processed by an indexer 124 to generate a reverse index (or indices) 126. This process is illustrated in greater detail below. The reverse index 126 can be continually updated as documents are added and/or updated. For example, crawlers or bots may continually or regularly retrieve documents to that the reverse index 126 contains up-to-date entries.

Still referring to FIG. 1, the user space 102 aspect of the system and method 100 is where the user(s) submit queries 128 and obtain a list of relevant documents in return. For example, the user space 102 may consist of a computer having a browser program capable of accessing a search engine via a network such as the Internet. As with the words obtained from the information space 106, the queries 128 submitted by the user(s) are in natural language form. The query 128 may be formed as a complete sentence, or more typically, as a plurality of keywords. Because of the limited context the short queries 128 provide, user submitted queries 128 are often highly ambiguous, such as “new driver” or “need driver.”

Most current search engines simply ignore these ambiguities and treat them as keywords, or use heuristics to make initial guesses as to what the user intended. In contrast, the system and method of the present invention improves upon this process by disambiguating the query 128 using a query processor 130 which is described in more detail below.

The output of the query processor 130 is a list of documents containing the query terms. Additionally, a ranked list of possible interpretations of the users' ambiguous queries 128 is produced, the first of which is considered as the most plausible. The output from the query processor 130 is then sent to the results processor 132, which then ranks the list of documents by their relevance. The search results are then combined, formatted, and ultimately sent displayed to the user 134 via a monitor or the like.

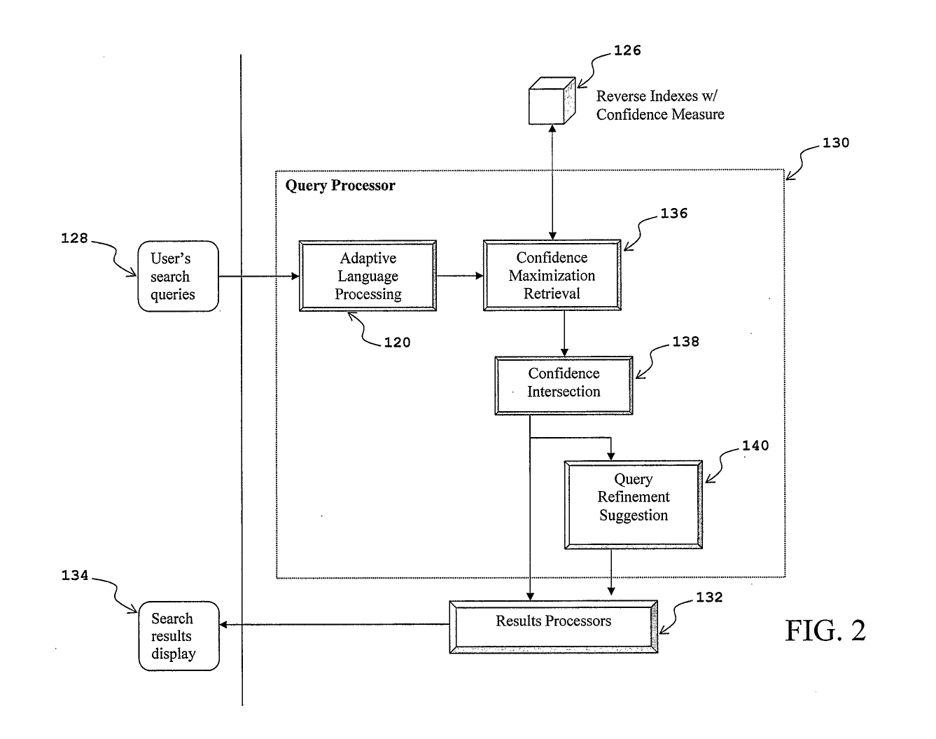

FIG. 2 is a more detailed schematic view of the query processor 130, whose main functions are to disambiguate the users' queries 128, retrieve a list of documents from the indexes 126, and make suggestions for improving the present query. As the users submit their queries 128, they are first disambiguated by the ALP module 120. Because of the limited contexts the queries 128 provide, the MOC values are lowered to reflect the higher amount of ambiguity. The initial disambiguation of the query 128 by the ALP module 120 parses the words into their word senses, or concepts. In a subsequent retrieval step 136, the concepts are then used to retrieve a list of documents that contain them the words submitted in the query 128 from the reverse indices 126. Importantly, ambiguity parameters (e.g., MOC values) are maintained for both the queries 128 and the indices 126.

Traditionally, when an error in language analysis is made, it causes a document to be permanently indexed by a search engine using the incorrect meaning. This problem is further exacerbated when highly ambiguous queries 128 are submitted. Consequently, conventional search engines return fewer relevant documents to the user. Moreover, the documents that are returned may contain irrelevant or the wrong content.

In contrast, the present system and method for information 100 retrieval maintains multiple interpretations and associate each with a confidence measure (e.g., MOC value). This is done for both the documents being searched as well as the users' query 128. With reference to FIG. 2, a list of documents containing the query words are retrieved 136 from the indices 126, plus the confidence measures (MOC values) of the meanings used in these documents. These measures are then combined with the disambiguated results obtained from a user's query 128 to form a confidence matrix, a process referred to as “confidence intersection” 138. The confidence intersection process 138 achieves two important tasks for the IR system. First, the users' queries 128 are disambiguated by choosing an interpretation that results in the highest value of the combined confidence values.

The goal of this process 138 is to choose the most confident meanings of query words that are contained in documents. This is an advancement over vector-based or ontology-based retrieval methods in that query disambiguation is based on the documents being searched, rather than a predefined computation of semantic similarity. Consequently, the system and method described herein is a dynamic method of disambiguation by mapping queries 128 to their meanings based on the ever-changing content of the document collection. This is an improvement over conventional approaches, where query disambiguation, if done at all, is done based on static methods for calculating similarity, regardless of the document collection.

A second task of the confidence intersection process 138 is to obtain a measure of document relevancy to the query 128. The MOC score for each document computed during confidence intersection process 138 is the system's certainty about the documents containing the correct meanings of the query words. By sorting on the document confidence scores, documents most similar to the disambiguated query are ranked higher on the results list, whereas less likely and possibly erroneous interpretations are placed lower on the list.

Still referring to FIG. 2, the results of the confidence intersection process 138 are then sent to the results processors 132 for further processing before returning the results to the users for display in step 134. However, the query disambiguation procedure described above is not infallible, and it is possible that the users are not looking for the more commonly used meanings of the query words. In one embodiment of the invention, users are given access to alternate interpretations of the query via an optional query refinement suggestion module 140. The query refinement suggestion module's 140 main function is to generate succinct presentations of alternate interpretations, instead of the internal representations generated by the ALP module 120. Additionally, there can potentially be an exponential number of possible interpretations, a select few of which the users might be interested in.

There are three types of suggestions the present system and method offers to the users. The first is based on phrasal ambiguities. Assume, for example, that the user's query is “special interest stall drives” (without the quotes). This is an ambiguous query with multiple interpretations. A safe and default action is simply to search for documents containing all four query terms. However, it is most likely that the user is searching for “‘special interest’ ‘stall’ ‘drives’”, i.e., “special interest” is meant as a compound noun phrase. In a scenario such as this, the suggestion module 140 would produce less ambiguous queries to help users refine their searches. In this example, the suggestion module 140 would produce the following four interpretations by adding quotes around phrases:

(1) “special interests” stall drives

(2) “special interests stall” drives

(3) special interests “stall drives”

(4) special “interests stall drives”

These four phrasal suggestions are generated by looking-up known phrases that are composed of consecutive query terms. These known phrases are automatically identified by a chunker that is part of the ALP module 120 as the ALP module 120 processes the document collection. Additionally, the potential suggestions may be weighted by their usage frequency, identifying the most likely phrase as “special interests” in this example. This look-up procedure is done efficiently using dynamic programming techniques which are known to those skilled in the art. In the above example, the other alternates makes little sense. However, since the suggestions are weighted by their usage frequency, the less useful suggestions are ranked lower. In one embodiment, the less frequent alternatives may be disposed of entirely and not presented to the users.

A second type of suggestion is part-of-speech (POS) ambiguity. For example, “drives” can be a noun, as in “floppy drives,” or a verb, as in “Jane drives.” The suggestions the present invention provides are exactly as in this example to distinguish this ambiguity. Specifically, a noun can be expanded into a noun phrase, a noun-verb, a verb-noun, or a adjective-noun pair. Likewise, a verb can be expanded into a noun-verb, verb-noun, adverb-verb, or verb-adverb pair. Similarly, an adjective can be expanded into an adjective-noun or a noun-is-adjective pair. Lastly, adverbs can be expanded into an adverb-verb, verb-adverb, or adverb-adjective pair.

These POS suggestion pairs are generated and weighed by their usage frequency within the documents, compiled by the indexer 124. Therefore, these suggestions are not predetermined by a dictionary or database. Rather, they are dynamically generated and updated with the content of the documents. Therefore, pairings with increasing popularity or archaic, technical terms are automatically incorporated.

The third type of suggestion is based on word sense ambiguity. This is the most challenging method for automatic suggestion. While synonym lists can be used, they are often long and can become laborious for the users to read. One possibility is to associate a short phrase with each unique concept within a lexicon, such as “financial bank,” “river bank,” and “racetrack bank” for these three senses of “bank.” The drawback of this method is the manual efforts needed to create and update these phrases and concepts.

Still another option is to use the definitions and/or example sentences from dictionary glossaries, which is a less labor intensive approach. However, this would also demand more from the user in reading the definitions. Also, they are less compositional if the queries contain multiple ambiguous words. Ultimately the decision is made by the system builder choosing a tradeoff between these intertwined parameters.

One additional function of the query refinement suggestion module 140 is to generate conceptually similar search queries. This is especially useful when the users are searching conceptually or are unsure of the exact vocabularies. Two such methods for automatically generating relevant suggestions are presented with both methods being centered around the disambiguated queries. This is an improvement over current suggestion methods, which are simply based on collocations of keywords. Collocations are generally unreliable since they are based on “shallow” linguistic features, in that suggestions are based on words that frequently occur next to each other, whether they are conceptually relevant or not. Even with ad hoc heuristics to extract more informative collocations, they are still not semantically disambiguated. Therefore, collocations such as “downloadable driver” and “driver education” are both suggested even though the users are unlikely to be searching for both meanings of “driver.”

The advantage of having the queries disambiguated is the semantic context they provide, such as a “computer driver” query would not produce suggestions about operating cars. Eliminating the noise from the suggestions based on semantic similarity is important to their usefulness. The suggestions are first compiled into a database during the indexing step in preparing the reverse indices 126, where the disambiguated phrases produced by the chunking step of the ALP module 120 are saved to a database, alongside with its usage frequency. For making suggestions, phrases that appear in the list of result documents are tallied and weighted by their usage frequencies.

The suggestions can be ranked based on their frequencies alone, or further refined based on their semantic similarities to the query. One approach is to use semantic distance as a measure of semantic similarity. This is typically computed based on an ontology where concepts are connected in a hierarchy. Semantic distances are computed by the number of “hops,” or degrees of separation between two concepts. These refined suggestions are therefore focused more on semantic relevance and less on usage frequencies. One downside to this approach is the added complexity and computation. However, the ultimate decision on tradeoffs between complexity/resource utilization and relevance of search results is a decision left for the system builder.

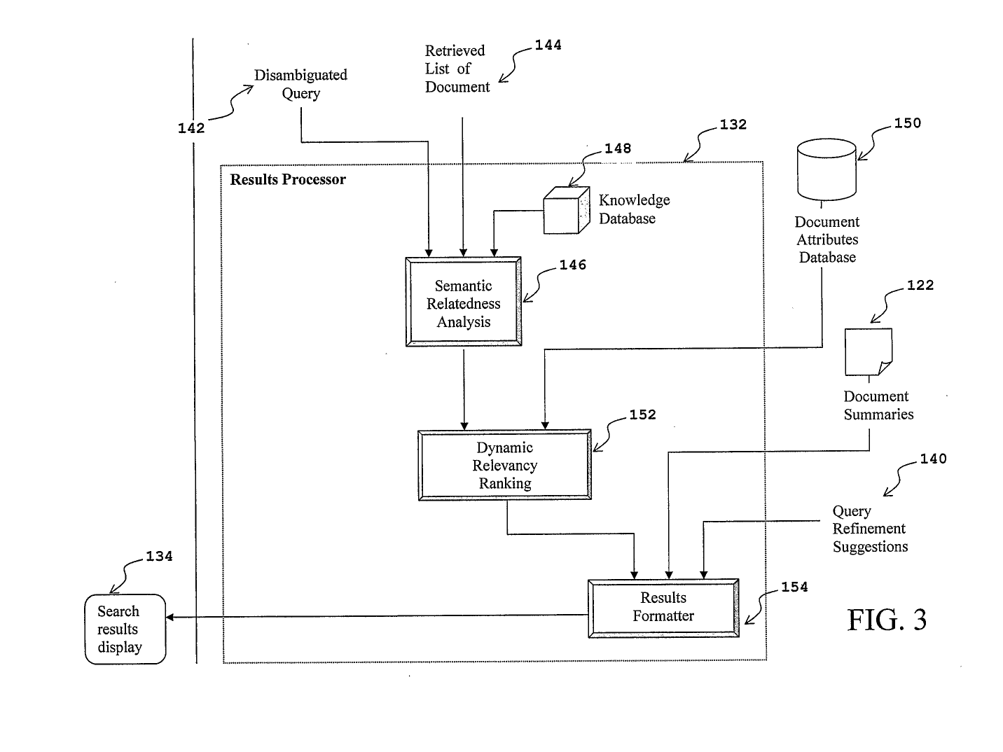

FIG. 3 is a more detailed schematic view of the results processing step/module 132 which combines the outputs from disambiguated query 142 to formulate a list of documents. The results processing step 132 may also provide a list of relevant alternate interpretations and a list of concepts semantically related to the query. A central function of the results processor 132 is to rank the relevance of the retrieved documents 144 retrieved by the query processor 130. Although this ranking of document relevance is initially based on their MOC scores, additional matrices may also be used to further refine the results.

One matrix is based on semantic relatedness 146, a concept introduced earlier for ranking suggestions. This improves the results by grouping and boosting or promoting documents that are more semantically similar to the query. That is, the semantic closeness of the entire document to the query is computed via semantic distance. This is computed efficiently by pre-computing distances between every two concepts within an ontology and saving it into a database 148. With the database 148, the semantic similarity of a document to the disambiguated query is computed by looking-up the pair-wise values of concepts within the document to the query terms. It is important to note that the disambiguated query 142 is essential to this step because semantic similarity cannot be calculated without it. While semantic distance has been described as a preferred method to determine semantic relatedness, other measures of similarity can be used provided they can be computed efficiently.

Other matrices for ranking of the documents are common to current search engines and may be implemented in the current system and method. These may include one or more of term frequency, text formatting, text positioning, document interlinking, document freshness and others. These matrices are compiled and stored in a database of document attributes 150 during pre-processing. A weighting measure may be given to each matrix to gauge its importance which may be chosen or altered by the system builder.

Still referring to FIG. 3, the values of these matrices are merged into a single relevancy score per document. The final list of results is then sorted in the order of their relevancy score 152. The present invention adds the measure of semantic relatedness, made possible by the automatic query disambiguation procedure. The result is a sorted list based on conceptual relevancy of the documents to the query, in addition to the traditional “shallow” features and link structures. Optionally, associated with each document returned to the user is a summary 122 of the document, or surrounding context where the query words appear. The summaries 122 are generated by the ALP module 120 and provide the user an indication of the document content.

Lastly, in one embodiment of the invention, optional suggestions generated by the query refinement suggestion module 140 are incorporated by a results formatter 154 to compose the final formatting of the results page for the user. Options for the formatting include HTML, XML, and the like, depending on user preference and applications. The formatted result page is then returned to the user for display 134.

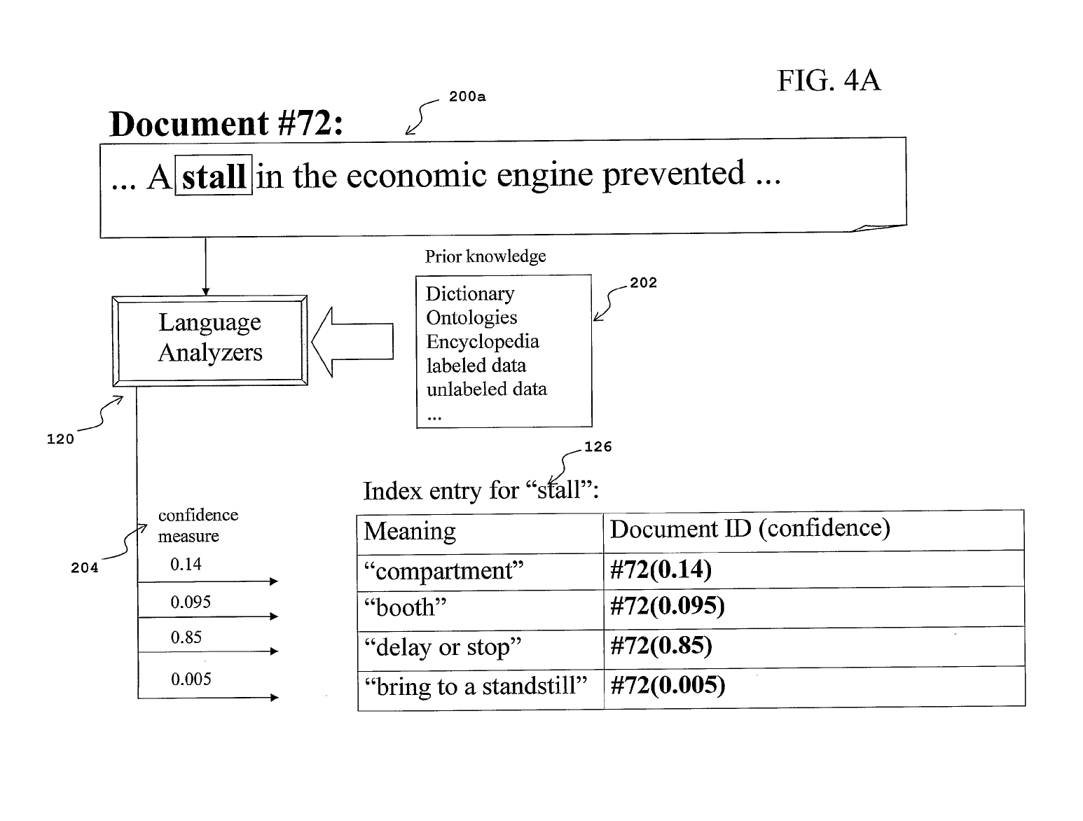

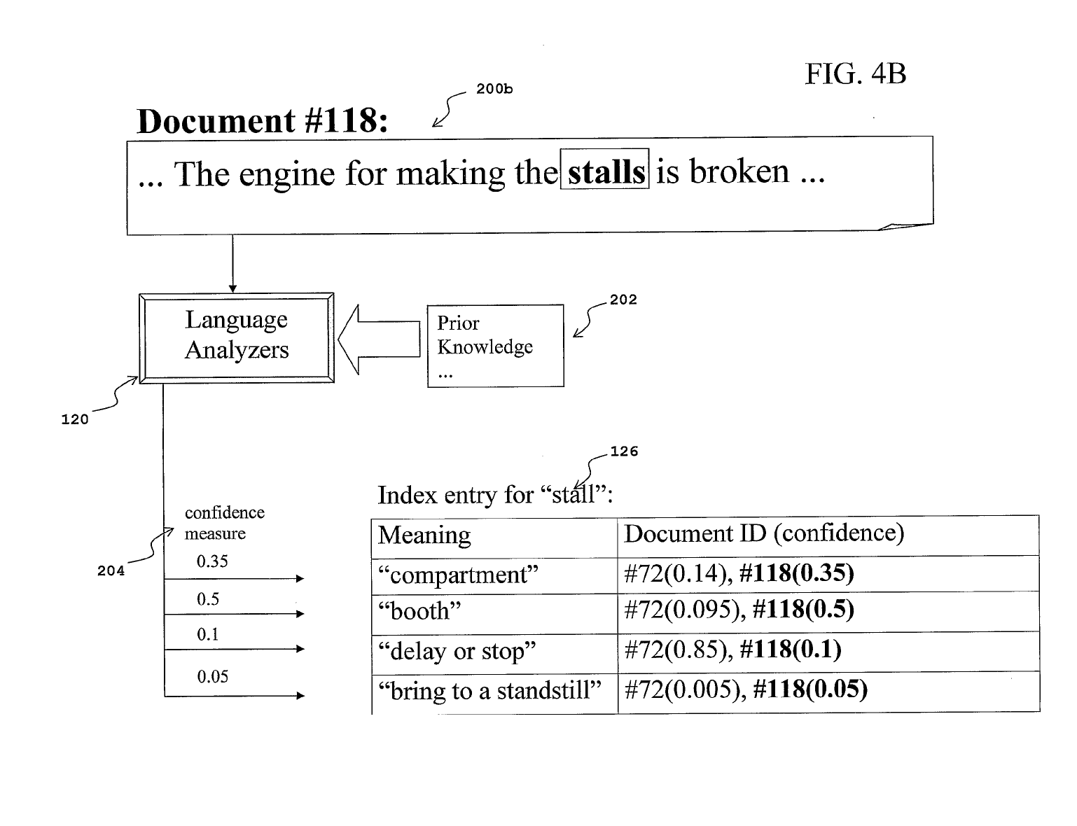

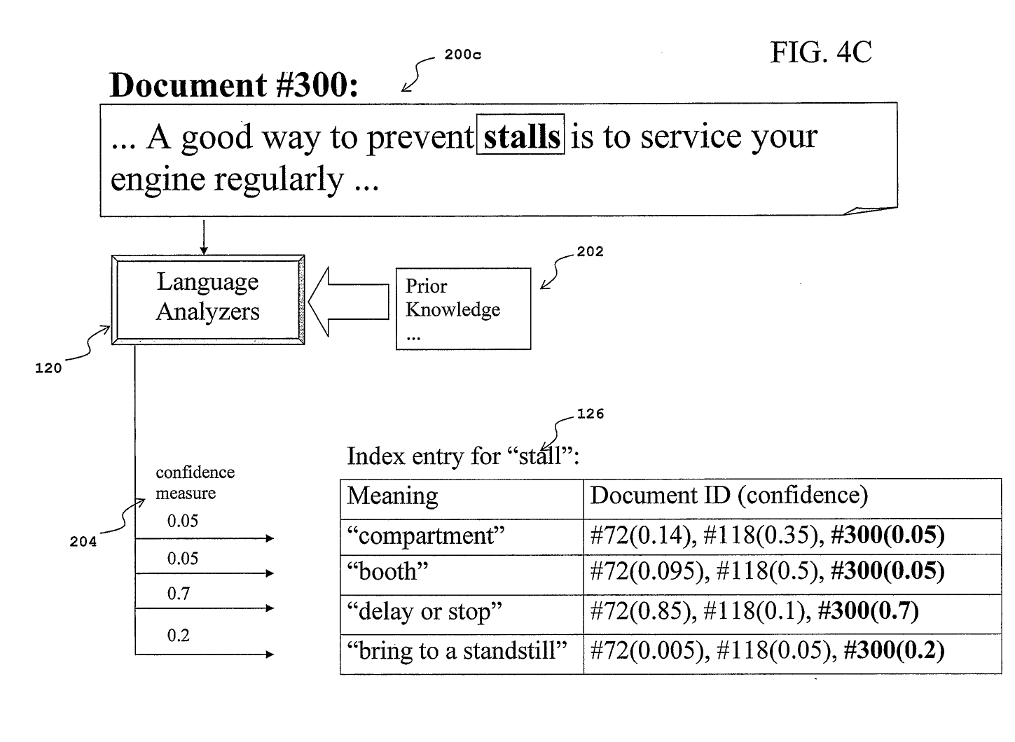

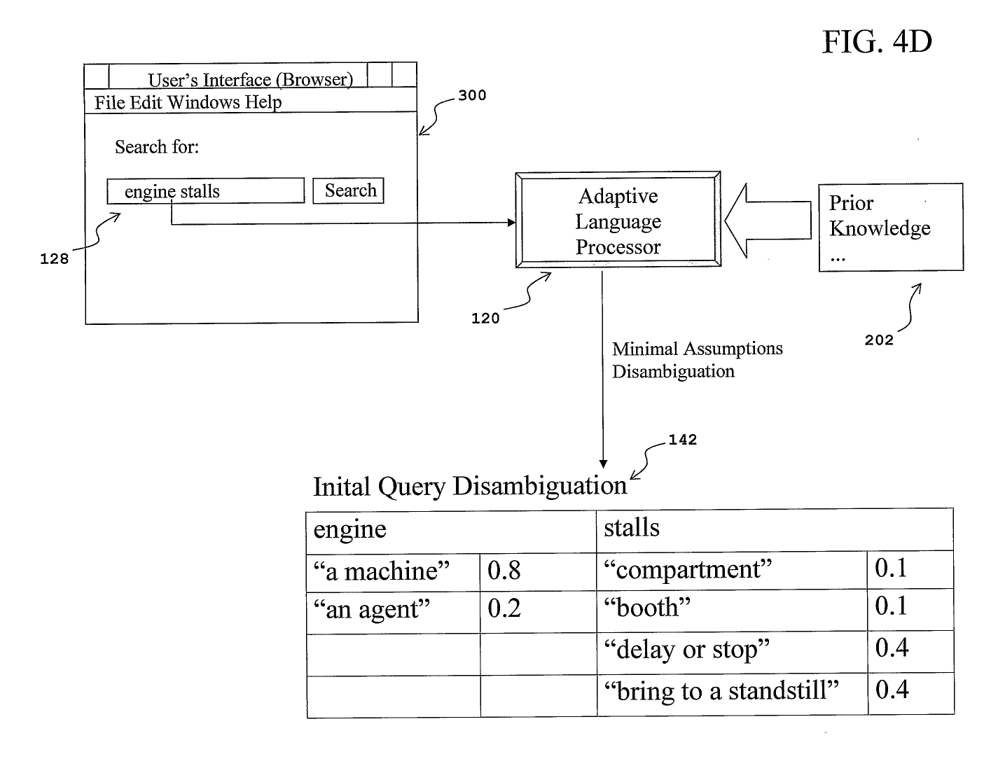

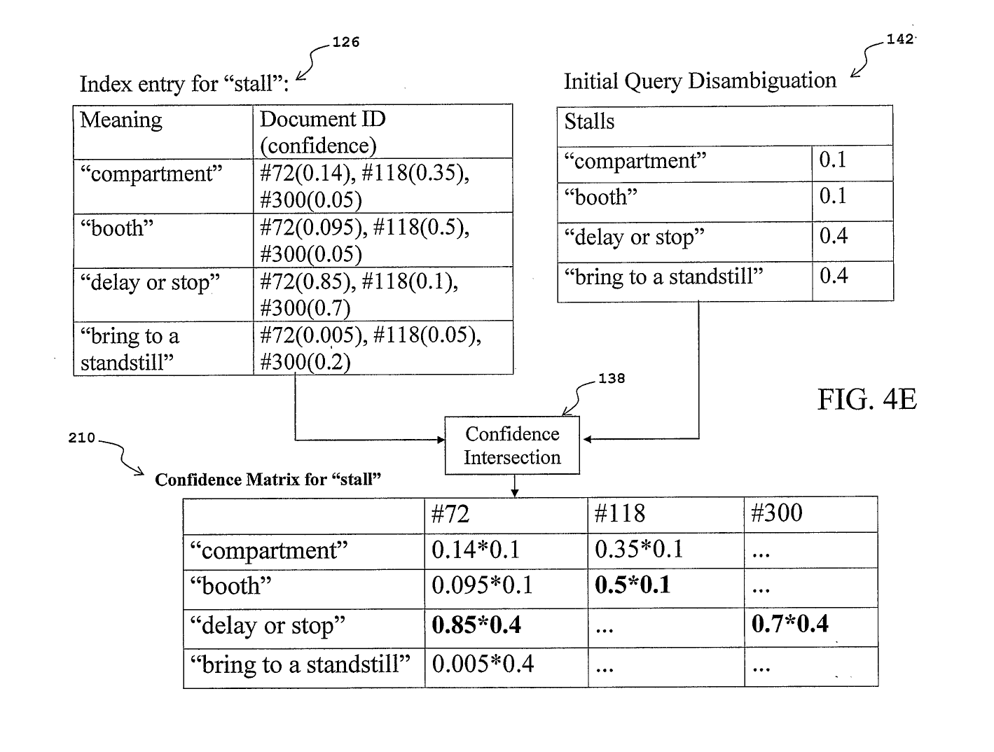

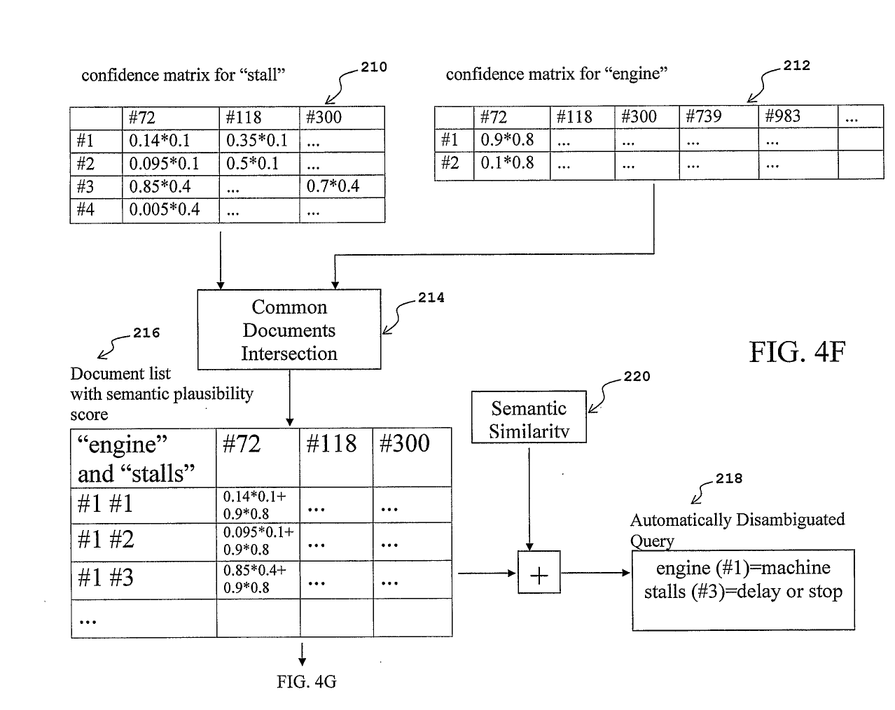

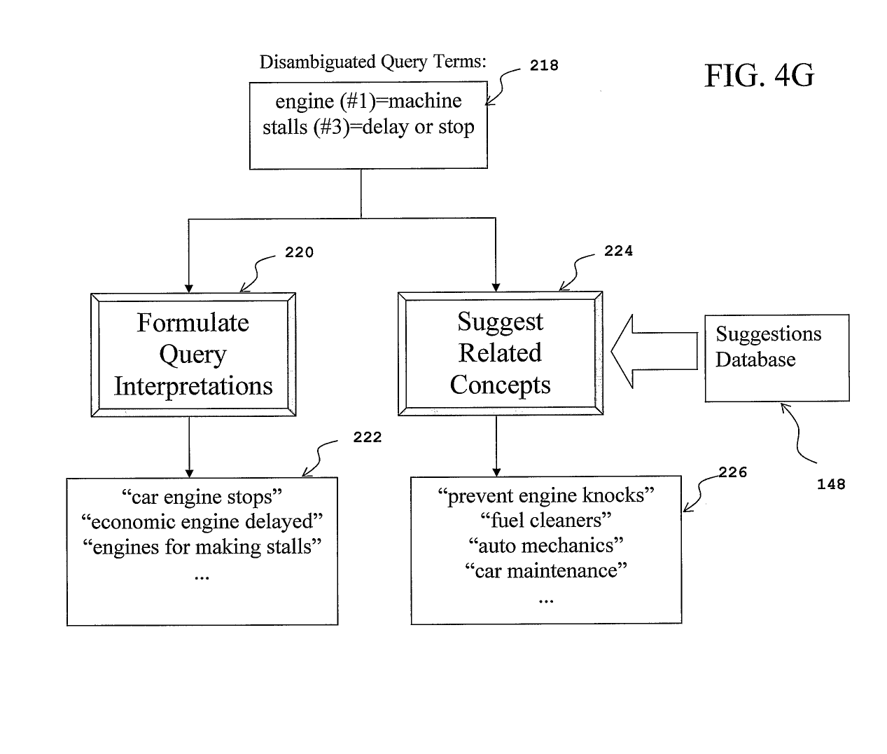

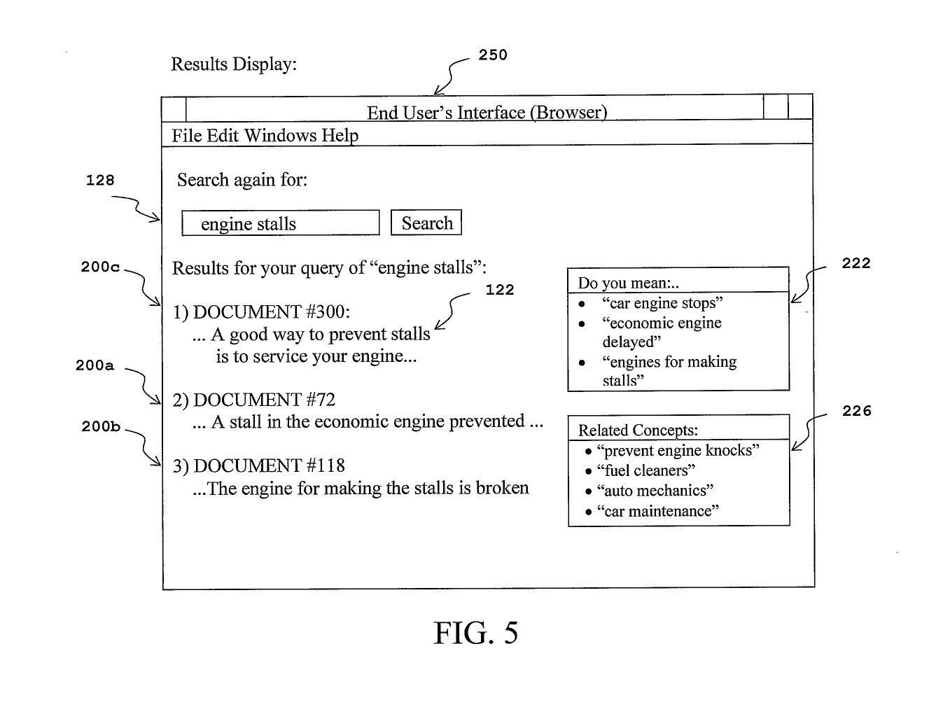

FIGS. 4A through FIG. 5 illustrate a series of steps demonstrating the operation of the information retrieval system according to one embodiment of the invention. The process begins with FIG. 4A, where a document 200a, numbered #72 for reference, is processed by the ALP module 120. The ALP module 120 incorporates prior knowledge 202 such as dictionaries and ontologies to best resolve language ambiguities. In this example, the ambiguous word “stall” is used to illustrate the process. Based on the context provided within document #72, the ALP module 120 produces the MOC value 204 for each of the four senses for “stall” with the “delay or stop” meaning as the most likely. The indexer 124 then saves this information into the entry for “stall” within the reverse index 126. Each entry of the reverse index 126 contains the document ID (#72 in this example), and the MOC value 204 for the different meanings of the word “stall.” The indexer 124 also performs the same operation for each word contained in the document.

FIG. 4B illustrates the same process as FIG. 4A but with a different document 200b (numbered as #118). The word “stalls” is used as a noun in this context, but it is ambiguous whether the meaning should be “compartment” or “booth.” The uncertainty is reflected in the MOC value 204 generated by the ALP module 120. The indexer 124 saves this information to the reverse index 126 by appending the document ID and the associated MOC value 204 to the existing entry for “stall.”

FIG. 4C illustrates a third document 200c being processed as described above. The MOC values 204 generated by the ALP module 120 are then indexed (via indexer 124) by appending the document ID with the respective MOC values 124. FIG. 4C illustrates the reverse index 126 being updated with entries from the third document. It should be noted that in this example the MOC value 204 for the third meaning (“delay or stop”) is lower than that from document 200a (ID #72).

FIG. 4D illustrates a method for processing a query input by a user according to one embodiment of the invention. The user, through an interface 300 located on a computer or other device, inputs a search query 128 and clicks on the “Search” button which sends the query 128 to the information retrieval system 100. The interface 300 may be accessed through a browser program or the like that is run on the user's computer. Of course, the interface 300 may also be accessible via devices other than a computer such as, for instance, a mobile phone, personal digital assistant, television and the like. In FIG. 4D, an example query 128 of “engine stalls” is processed by the ALP module 120 as described in detail herein. Although this query 128 does not seem ambiguous, a user can be searching for any of the three documents 200a, 200b, 200c illustrated in FIGS. 4A, 4B, 4C. A conventional search engine would find all three documents 200a, 200b, 200c equally relevant even though the user is most likely searching for only one of the three distinct topics.

The information retrieval system 100 overcomes this shortcoming by inferring what the user is searching for conceptually. However, due to the limited context, reliably disambiguating the query 128 is difficult. While most would assume that the user is searching for something akin to “my car motor stops,” such assumptions can often be wrong and lead to irrelevant results. In this example, minimal assumptions are made during the disambiguation step 142 by the ALP module 120 such that an equal likelihood is given that “stalls” means “delay or stop” (a noun sense) or “bring to a standstill” (a verb sense). This can be seen by the equal MOC values 204 (0.4 in this case) associated with the query 128. This output constitutes as the initial query disambiguation 142 and is further refined as described below.

FIG. 4E illustrate the next step of the process, where the “stall” portion of the query from the previous step 142 is combined with the entry for “stall” within the reverse index 126 from FIG. 4C. These two entries are then combined in a confidence intersection step 138. The result is a confidence matrix 210 which has four rows for each meaning of the word “stall” and three columns for each document containing the word “stall.” The cells where the confidence scores are the highest are shown in bold. As can be seen from FIG. 4E, the third meaning “delay or stop” is favored.

The same process may be undertaken with respect to the query word “engine.” In one aspect of the invention, the sense or meaning of “engine” may be determined independently of the sense or meaning of “stall.” This may be preferred, for example, if efficiency is a concern. In another aspect of the invention, query ambiguity is resolved across multiple query terms. FIG. 4F illustrates how query ambiguity is resolved across the query terms “stall” and “engine.” The two confidence matrices for “stall” 210 and engine 212 are first combined to determine documents common to both 214. This is equivalent to a Boolean “and” search. Of course, if a disjunction of the query term is desired, a union of the document list can be used instead. The result of this intersection is a list of documents 216 containing both query terms, three of which are shown in the columns.

For each of the three documents a permutation of the different meanings of the query words is generated to determine the combined likelihood of that particular meaning combination used within the document. In this step, the query words influence each other because of the examination of the senses that are the most likely to be contained within the same set of documents. In doing so, the query terms do not have to be semantically similar to each other, as was necessary in previous methods that rely on the query terms alone. Instead, the information retrieval system 100 looks for the most commonly used senses of query terms within the documents containing them. Therefore, the present invention leverages the content of the documents to automatically disambiguate the senses of query terms.

The final step 218 is to automatically disambiguate the query 128 is to select the maximal sense combination across all three documents 200a, 200b, 200c, which in this example is the first sense for “engine” and third sense for “stall.” If further refinement is desired, an optional semantic similarity processing step 220 between each sense combination can be added as a measure of semantic plausibility. The result is an automatic, efficient and accurate method to disambiguate the users' queries 128.

FIG. 4G illustrates the two types of suggestions that are generated based on the disambiguated query terms 218. One type of suggestion is the generation 220 of alternate query interpretations 222. The resultant alternate query interpretations 222 may be retrieved from the suggestion database described earlier (e.g., database 148 as shown in FIG. 3). In this case, alternative query interpretations 222 include, for example, “economic engine delayed” or “engines for making stalls.” These suggestions may then sorted based on the semantic plausibility scores 220 as shown in FIG. 4F.

Another suggestion method generates 224 related concepts 226 such as “prevent engine knocks” and “fuel cleaners.” These suggestions may be based on linguistically accurate meanings that were collected and stored in a language database 148.

Referring to FIG. 5, the outputs are combined into a format suitable for display to the user. As shown in FIG. 5, the results display is shown in a user interface such as a browser window 250. In one embodiment of the invention, the search results are displayed in addition to alternate query interpretations 222 and suggested related concepts 226. At the top of the page the current query terms are displayed, which in this case is “engine stalls.” Below the query terms is a list of documents 200c, 200a, 200b in descending order or relevance. In this example, document 200c (Document #300) is ranked the highest because of its closeness to the query terms conceptually. An optional summary 122 of document 200c is shown directly below to provide the user with context of the document. The next most relevant document 200a (Document #72) is more conceptually distal from the query terms. The last document 200b (Document #118) is deemed to be the least relevant by the information retrieval system 100.

As stated earlier, the relevancy of the documents 200a-200c is computed based on the automatically disambiguated query terms. However, this automated process is not infallible. Therefore, in one aspect of the invention, search results are displayed along with alternate query interpretations 222 and suggested related concepts 226. In this example the automatically determined interpretation is “car engine stops,” which is shown at the top of the list as reference to the user. Likely alternate interpretations are provided below, which are links that encodes the exact meanings of these alternates. For example, if the user chooses the alternate meaning of “economic engine delayed,” query disambiguation need not be done (such processing having already occurred). Instead, search results are re-scored and ranked such that documents containing the “economic engine” meaning are presented first. In this example, document 200a (Document #72) would then be ranked highest. In addition, as seen in FIG. 5, based on the current meaning of the query being the “car engine stops,” suggestions to related concepts are presented in the form of suggested related concepts 226. These suggestions 226 are provided as links to additional queries so users can click on them to quickly search for documents. These suggestions 226 are collected automatically from within the documents. Consequently, the query terms are already disambiguated. Therefore, the links for both alternate query interpretations 222 and related concepts 226 provide convenient and precise access to documents conceptually related to the current results.

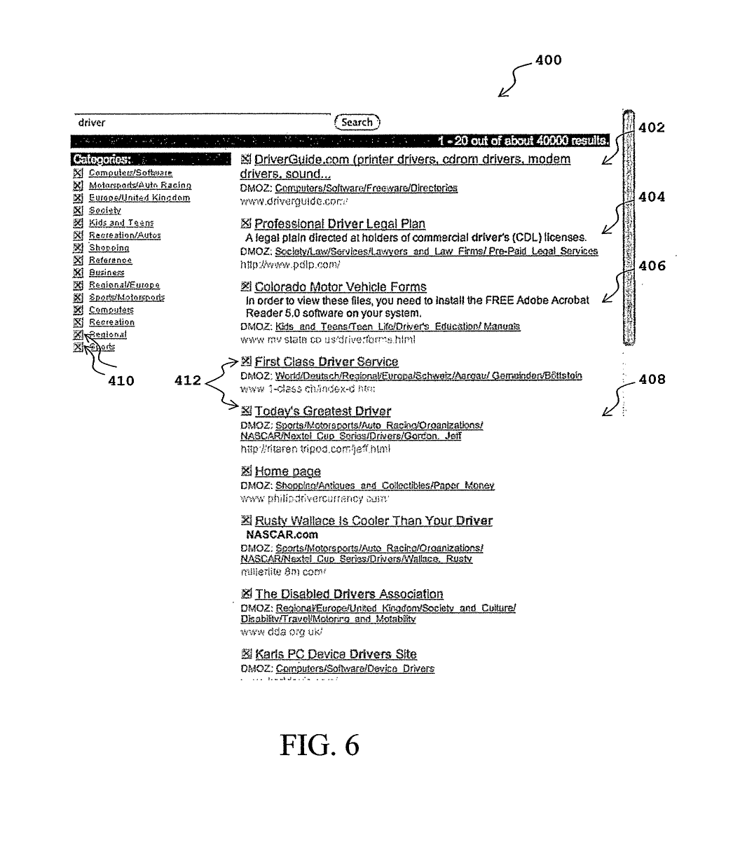

FIGS. 6-9 illustrate another embodiment of the information retrieval system 100. In this embodiment, a user interface 400 is provided that permits the user to selectively remove one or more documents 402, 404, 406, 408 from the initially presented list. Once the document(s) are removed, the list is re-ranked with the selected documents (e.g., 404) being removed from the list. In addition, documents conceptually related to the excluded document(s) (e.g., 404) may be removed. In another aspect of the invention, a user is able to exclude an entire category 410 of documents from the list.

The embodiment illustrated in FIGS. 6-9 is shown by an exemplary query of “driver.” For instance, suppose a user intended “driver” to mean “one who drives a vehicle” instead of, for example, drivers used in connection with computer software and hardware devices. In the list shown in FIGS. 6-8, an exclusion tag 412 is placed next to each search result in the list. The exclusion tag 412 may be formed as a button (e.g., clickable radio button or the like) located next to each search result. The exclusion tag 412 tells the search engine to “remove” the particular document. For example, the user can click the exclusion tag 412 next the result about computer software. In the example shown in FIG. 6, the result next to “Colorado Motor Vehicle Forms” is selected by checking or un-checking (as shown in FIG. 6) the exclusion tag 412. When the search engine receives this input, a similarity computation is done to measure each result for “driver” to the one the user removed.

In this case the similarity computation measures how similar each document is to the removed document. For example, if the user excluded a “driver” listing for computer software, the similarity measurement would be made between each document in the list and “computer software.” The relevance of the results is then adjusted as inversely proportional to this similarity, since the user indicated his or her disinterest in documents pertaining to computer software. Thus, the results are re-ranked so that documents about software are demoted or removed entirely, while more relevant documents, such as ones about car drivers, replace them. Therefore, by a simple click of the mouse, the user not only removes the irrelevant document (e.g., document 406), but also those similar to it. Therefore, this invention allows the users to make their search results more relevant, intuitively and with minimum effort.

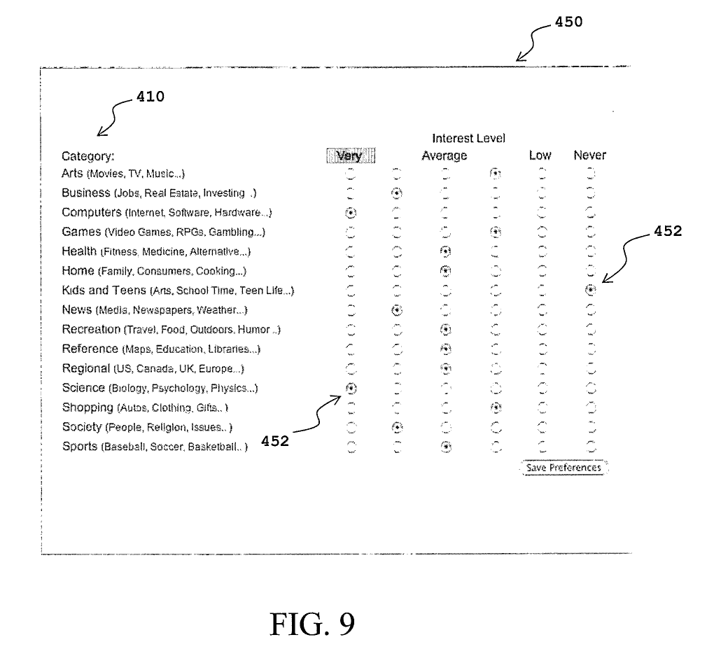

The effectiveness of the re-ranking lies in computing the similarity measure. There are various methods for this computation, such as probabilistic classification, semantic similarity, neural networks, vector-based clustering. The particular method of similarity determination can vary. For example, the method can be trained via positive or negative evidence and similarity value can be computed given new data. In one aspect of the invention, the positive evidence is composed of the documents that the user did not exclude. That is, the documents that a user is interest in are determined implicitly, as the inverse of those the users excluded explicitly. The positive evidence can also be gathered explicitly by user preferences (as explained below with respect to FIG. 9), previous searches, browsing history, and bookmarks. The negative evidence is comprised of those the users excluded by clicking on the exclusion tag 412. Similarly, negative evidence may be augmented with preferences and histories.

Given a collection of positive and negative evidence, a probabilistic classifier, for example, can be trained to compute the probability of exclusion given the context from the documents, i.e., P(exclude=true|<context>). Once trained, the classifier can then compute this probability for each document in the results, which is the likelihood of it being similar to the set of excluded documents. This probability is then factored into the inverse re-ranking process described above.

Another possibility is to use semantic similarity to measure the likeness of two documents. For example, a race car driver is semantically closer to a truck driver than to computer software. Conversely, a software driver is semantically closer to an electronic circuit driver and not vehicle operators. The most common method for comparing semantic similarity is via an ontology, where concepts are organized in an hierarchy and are grouped into semantically similar concepts. To determine the similarity between concepts, one can simply use the degree of separation between them, i.e., semantic distance. The degree of separation may be determined by the number of hops or degrees of separation between related concepts. Optionally, the semantic distance may be augmented or modified with semantic density and probabilistic weighting.

Semantic similarity is attractive because it is more intuitive and can be more efficient. However, the challenge lies in first categorizing each document into a concept inside an ontology, such as using a probabilistic classifier to compute probability of a category given the document context, P(category|<context>). That is, each document is first mapped into a “conceptual” space. In serving a user's exclusion request, therefore, the similarity measure between documents to the training set becomes fast look-ups for similarity between the concepts they are mapped into.

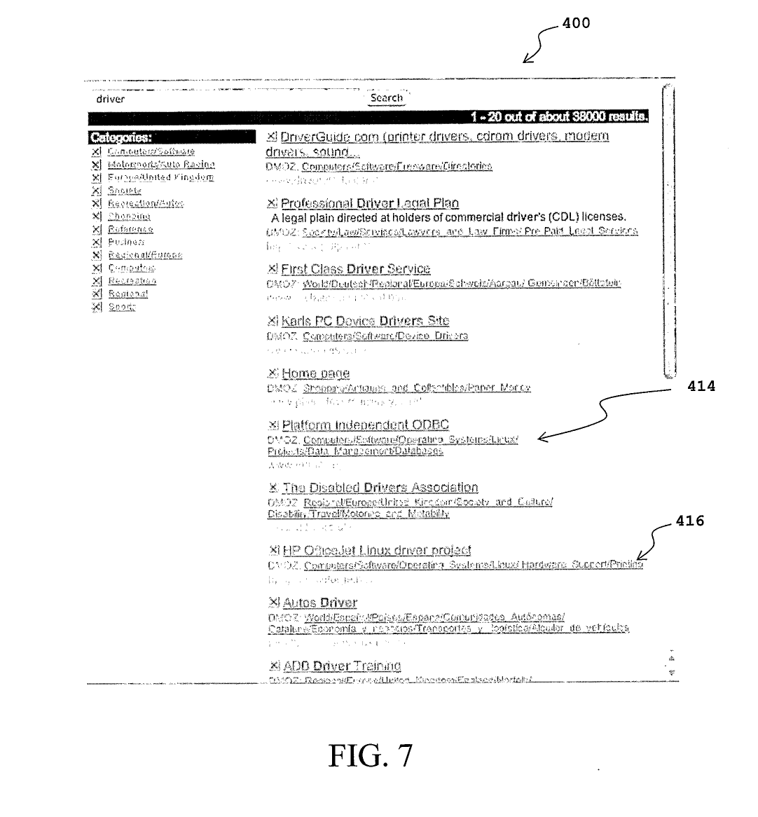

FIG. 7 illustrates a re-ranked list of documents after document 406 (in FIG. 6) was selected for removal. Located in the list are two documents 414, 416 that relate to computer/software drivers. The user, however, does not want such “driver” documents 414, 416. These documents 414, 416 may be removed from the list by selecting (or de-selecting) the exclusion tag 412 associated with each document.

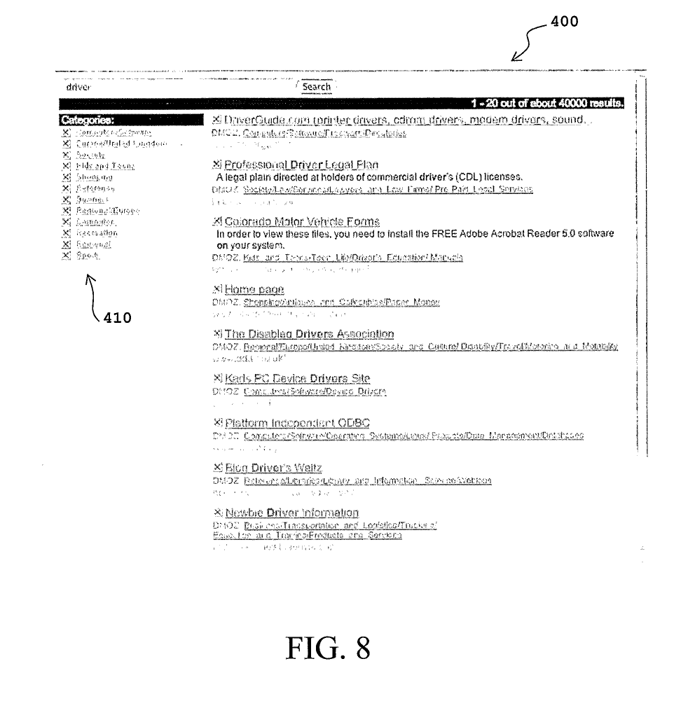

FIG. 8 illustrates one aspect of the invention where an initially ranked list of documents has an entire category 410 of documents removed. In the example shown in FIG. 8, the re-ranked list of documents has had all “Motorsports/Auto Racing” documents removed from the list (FIG. 8 omits the Motorsports/Auto Racing category found in FIG. 7). In addition, those documents conceptually related to motorsports and auto racing are removed from the list.

FIG. 9 illustrates a user preference screen 450 that can be used to provide the search engine with user interest level on a number of distinct categories. For example, under the “Science” category, the user may select (or de-select as the case may be) a button 452 or the like that indicates a very high level of interest. In contrast, for a category such as “Kids and Teens” the user may select a button 452 indicating that the user is never interested in such subject matter. The user preferences can then be saved either locally or remotely, for example, on a remote server or the like. When the user searches using the search engine, the various preference interest levels are integrated into the ranking of the documents in the results list. Documents related to subject matter that the user is interested in are elevated or promoted higher on the list while documents related to subject matter that is of little or no interest to the user is demoted or removed entirely from the displayed list.

With respect to the user-based preferences embodiment, the ontology-based approach to determining similarity is amendable for such user customization, allowing each user to specify their interest in the concepts, such as computers versus sports versus shopping. This information can be used to rank result relevance without any explicit user input (i.e., exclusion) by computing each search result to the user's profile. Upon explicit feedback from the user, the results can be further tailored for the needs of the user.

While embodiments of the present invention have been shown and described, various modifications may be made without departing from the scope of the present invention. The invention, therefore, should not be limited, except to the following claims, and their equivalents.

1. A method of indexing documents for use with a search engine comprising:
identifying the words contained in a document;
processing the words contained in the document in an adaptive language processing module so as to associate each word with a measure of confidence value, the measure of confidence value being associated with a particular ambiguity of the word;
storing each word and its measure of confidence value in a reverse index along with location information for the document.

2. The method of claim 1, wherein each word is associated with a part-of-speech tag identifying the grammatical usage of the word within the document.

3. The method of claim 2, wherein the part-of-speech tag is associated with a measure of confidence value.

4. The method of claim 1, wherein each word is associated with a word sense value identifying a particular meaning of the word.

5. The method of claim 4, wherein the word sense value is associated with a measure of confidence value.

6. The method of claim 1, wherein the adaptive language processing module generates a summary of the document.

7. The method of claim 1, wherein the particular ambiguity of the word comprises a word meaning.

8. The method of claim 1, wherein the measure of confidence value is based at least in part on the number of ambiguous meanings of the word.

9. A method of retrieving documents using a search engine comprising:
providing a reverse index including one or more keywords and a list of documents containing the one or more keywords, the reverse index further including a measure of confidence value associated with the one or more keywords;
inputting one or more query terms into to the search engine;
identifying one or more meanings for each query term and associating each meaning with a measure of confidence value;
retrieving a list of documents containing the one or more query terms, wherein the documents are ranked based at least in part on the measure of confidence value associated with the one or more keywords contained in the documents and the measure of confidence value associated with each query term meaning.

10. The method of claim 9, wherein the measure of confidence value of the one or more keywords corresponds to a particular keyword meaning.

11. The method of claim 10, wherein the documents having a keyword meaning most similar to the query term with the highest measure of confidence value are ranked higher.

12. The method of claim 1, further comprising the step of presenting a ranked list to a user.

13. The method of claim 11, wherein documents are further ranked based on a semantic similarity between the documents and the one or more query terms.

14. The method of claim 9, further comprising the step of presenting a user with one or more alternative queries.

15. (canceled)

16. (canceled)

17. The method of claim 14, wherein the one or more alternative queries are based at least in part on: speech pairings of multiple keywords contained with the documents, a synonym of one or more query terms, a definition of one or more query terms, the disambiguated query a usage frequency, or a semantic similarity to the input query.

18. (canceled)

19. (canceled)

20. (canceled)

21. (canceled)

22. (canceled)

23. A method of retrieving documents using a search engine comprising:
providing a reverse index including one or more keywords and a list of documents containing the one or more keywords, the reverse index further including a measure of confidence value associated with the one or more keywords;
inputting one or more query terms into to the search engine;
disambiguating the query terms by obtaining a measure of confidence value for each query term based at least in part on the meaning of each query term;
retrieving a list of documents containing the one or more query terms, wherein the retrieved documents are initially ranked based at least in part on the measure of confidence value associated with the keyword contained in document and the measure of confidence value associated with each query term meaning; and
re-ranking the list of documents at least in part based the semantic similarity of each document to the disambiguated query terms.

24. The method of claim 23, wherein the semantic similarity of a document to the disambiguated query is determined by looking up pre-computed distances between every two concepts within an ontology.

25. The method of claim 23, wherein the re-ranking is based at least in part on one or more parameters selected from the group consisting of term frequency, text formatting, text positioning, document interlinking, and document freshness.

26. The method of claim 25, wherein the re-ranking is based on a weighted value of the one or more parameters.

27. The method of claim 23, wherein the documents reside in a network, a local computer, or a database.

28. (canceled)

29. (canceled)

30. (canceled)

31. A method of retrieving documents using a search engine comprising:
submitting a query to a search engine;
presenting a user with a list of documents, the list including an exclusion tag associated with each document in the list;
selecting one or more exclusion tags in the list to exclude one or more documents;
determining a similarity measure for each document in the list based at least in part on the similarity of the document to those documents associated with a selected exclusion tag; and
re-ranking the list of documents based on the determined similarity measure, wherein those documents most similar to the excluded documents are demoted or removed from the re-ranked list.

32. (canceled)

33. The method of claim 31, further comprising the step of providing the user with a list of categories, each category including an exclusion tag associated therewith, wherein selection of the exclusion tag associated with a particular category excludes documents from the re-ranked list that fall within the particular category.

34. The method of claim 31, wherein those documents most dissimilar to the excluded documents are ranked highest.

35. A method of retrieving documents using a search engine comprising:
establishing a user preference for a plurality of categories of documents;
submitting a query to a search engine;
determining a similarity measure between the documents based at least in part on the similarity of the documents to the established category preferences; and
presenting the user with a list of documents, wherein the documents are ranked based on the determined similarity measure.

36. The method of claim 35, further comprising the steps of:
presenting the user with a list of documents, wherein the list includes an exclusion tag associated with each document in the list;
selecting one or more exclusion tags in the list to exclude one or more documents;
determining a similarity measure for each document in the list based at least in part on the similarity of the document to those documents associated with a selected exclusion tag; and
re-ranking the list of documents based on the determined similarity measure, wherein those documents most similar to the excluded documents are removed from the re-ranked list.
